(19) United States
(12) Patent Application Publication
(10) Pub. No.: US 2018/0275451 A1
(43) Pub. Date: Sep. 27, 2018

(54) DISPLAY PANEL AND MANUFACTURING METHOD THEREFOR

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/555,398

(22) PCT Filed: Jul. 7, 2017
(86) PCT No.: PCT/CN2017/092167

§ 371 Date: Sep. 1, 2017

(30) Foreign Application Priority Data
Mar. 10, 2017 (CN) 201710142432.X

(51) Int. Cl. G02F 1/1335; G02F 1/1362; G02F 1/1368

(52) U.S. Cl. CPC G02F 1/133512; G02F 1/133528; G02F 1/1341; G02F 1/1368; G02F 1/136286

(57) ABSTRACT

This application provides a display panel and a manufacturing method therefor. The display panel includes: a transparent substrate; an active switch array substrate, disposed opposite to the transparent substrate, and having an outer surface; and a polarizer, disposed on the outer surface of the active switch array substrate, where the polarizer has a light shielding part, disposed at a periphery of the polarizer.

### BACKGROUND

### Technical Field

This application relates to a frame-less design method, and in particular, to a frame-less display panel and a manufacturing method therefor.

### Related Art

TFT-LCD is the abbreviation of thin film transistor liquid crystal display. The TFT-LCD is a backlight liquid crystal display, and includes an LCD panel and a backlight module. The LCD panel includes: a first substrate—a color filter (CF) substrate, a second substrate—a thin film transistor (TFT) substrate, and liquid crystal (LC) between the CF substrate and the TFT substrate. However, a low temperature poly-silicon (LTPS) process is a manufacturing process of a new-generation TFT-LCD. The largest difference between a LTPS display and a conventional amorphous silicon (a-Si) display is that a response speed of the LTPS display is faster, and the LTPS display has advantages such as a high luminance, a high resolution, and low power consumption. Poly-silicon and a-Si technologies can be applied to TFT-LCDs. Currently, a-Si technology is applied to most of the TFT-LCDs, and related technology is relatively mature. Because a liquid crystal display (LCD) cannot emit light, a backlight module is needed. The backlight module may include a light source such as a light emitting diode or a fluorescent lamp, a light guide plate, a prism sheet, a diffusion sheet, a protection sheet, and the like.

To highlight a sense of unity of a display image, TFT-LCDs are developed to be frame-less. However, after frames are canceled, a problem of side light leakage at edges needs to be resolved, and otherwise a phenomenon of peripheral light leakage at edges occurs. In addition, when a frame-less product displays a panel array side upward, light reflected by surrounding metal causes a poor visual sense, affecting quality of the panel.

### SUMMARY

To resolve the foregoing technical problem, this application is intended to provide a frame-less design method, and in particular, relates to a display panel and a manufacturing method therefor, so that light reflected by metal surrounding a TFT glass substrate can be absorbed, a problem of poor visual sense resulted from the light reflected by the metal is mitigated, and a scratch loss caused by flipping the substrate is reduced.

The objective of this application and the resolved technical problems are achieved by using the following technical solutions. This application provides a display panel, comprising: a transparent substrate; an active switch array substrate, disposed opposite to the transparent substrate, and having an outer surface; and a polarizer, disposed on the outer surface of the active switch array substrate, where the polarizer has a light shielding part, disposed at a periphery of the polarizer.

In an embodiment of this application, the active switch array substrate comprises a peripheral metal wiring, disposed at a periphery of the active switch array substrate, and the light shielding part shields the peripheral metal wiring.

In an embodiment of this application, the light shielding part is a dark light-absorbing material or a material with a low reflective rate.

In an embodiment of this application, the light shielding part is a carbonized material.

In an embodiment of this application, the light shielding part is formed by carbonizing the periphery of the polarizer by using high-intensity light energy. The high-intensity light energy is a laser or ultraviolet light.

Another objective of this application is to provide a display panel manufacturing method, comprising: providing a transparent substrate; providing an active switch array substrate, disposed opposite to the transparent substrate and having an outer surface; disposing a polarizer on the outer surface of the active switch array substrate; and changing a material property of the polarizer by using high-intensity light energy to illuminate a periphery of the polarizer, to form a carbonized light shielding part at the periphery of the polarizer.

In an embodiment of this application, the active switch array substrate comprises a peripheral metal wiring, disposed at a periphery of the active switch array substrate, and the light shielding part shields the peripheral metal wiring.

In an embodiment of this application, the carbonized light shielding part is a dark light-absorbing material or a material with a low reflective rate.

In an embodiment of this application, the high-intensity light energy is a laser or ultraviolet light.

In an embodiment of this application, the light shielding part is carbonized and formed by using the high-intensity light energy in a process of manufacturing the polarizer.

In an embodiment of this application, the light shielding part is carbonized and formed by using the high-intensity light energy after the polarizer is attached.

Still another objective of this application is to provide a display panel, comprising: a transparent substrate; an active switch array substrate, disposed opposite to the transparent substrate, and having an outer surface; a liquid crystal (LC) layer, disposed between the transparent substrate and the active switch array substrate; a seal, disposed at a periphery between the transparent substrate and the active switch array substrate, and surrounding the LC layer; and a polarizer, disposed on the outer surface of the active switch array substrate, where the active switch array substrate comprises a peripheral metal wiring, disposed at a periphery of the active switch array substrate; the polarizer has a light shielding part, disposed at a periphery of the polarizer, and the light shielding part shields the peripheral metal wiring; the light shielding part is formed by carbonizing the periphery of the polarizer by using high-intensity light energy, and the high-intensity light energy is a laser or ultraviolet light; and the light shielding part is a carbonized material, and the light shielding part is a dark light-absorbing material or a material with a low reflective rate.

According to this application, light reflected by metal surrounding a TFT glass substrate can be absorbed, a problem of poor visual sense resulted from the light reflected by the metal is mitigated, and a scratch loss caused by flipping the substrate is reduced.

### BRIEF DESCRIPTION OF THE DRAWINGS

FIG. 1 is a schematic structural diagram of a backlight module of an exemplary conventional LCD;

FIG. 2a is a schematic diagram of an exemplary panel array layer;

FIG. 2b is a schematic diagram of an array layer of a display panel according to an embodiment of this application; and

FIG. 3 is a polarizer manufacturing method according to an embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” another component, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of the gravity direction.

To further describe the technical means adopted in this application to achieve the intended inventive objective and effects thereof, specific implementations, structures, features, and effects of a display panel and a manufacturing method therefor provided according to this application are described below in detail with reference to the accompanying drawings and preferred embodiments.

An LCD means that an electric field is applied to LCs between two glass substrates, to display a number or an image. The LCs include a material between a liquid and a solid. Because the LCD cannot emit light, a backlight module is needed to provide light. A picture is formed by controlling transmission of light from an LCD panel. The LCs are evenly disposed in the LCD panel.

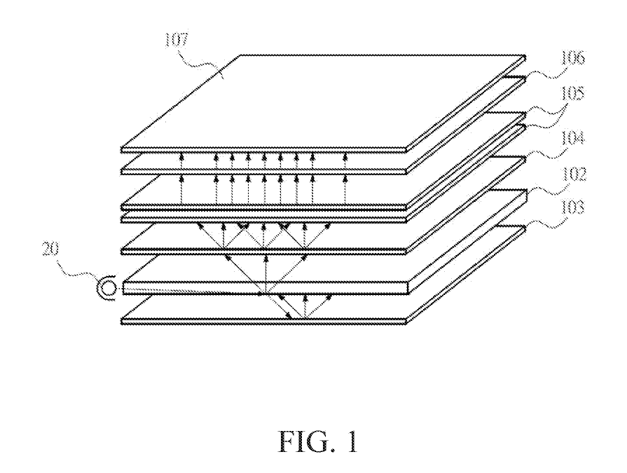

FIG. 1 is a schematic structural diagram of a backlight module of an exemplary conventional LCD. Referring to FIG. 1, the backlight module of the conventional LCD includes a light source 20, a light guide plate 102, a reflection sheet 103, a diffusion sheet 104, prism sheets 105, and a protection sheet 106. First, the light source 20 is used to emit light to the LCD. Currently, a plurality of different light sources may be applied to the LCD. The light guide plate 102 is disposed below an LCD panel 107, and is adjacent to one side of the light source 20. The light guide plate 102 is configured to convert point light generated by the light source 20 into planar light, and project the planar light onto the LCD panel 107.

The reflection sheet 103 is disposed below the light guide plate 102. The reflection sheet 103 is configured to reflect the light emitted from light source 20 to the LCD panel 107 in front of the reflection sheet 103. The diffusion sheet 104 is disposed on the light guide plate 102, and configured to homogenize light passing through the light guide plate 102. When the light passes through the diffusion sheet 104, the light is diffused in vertical and horizontal directions. In this case, the brightness of the light rapidly reduces. In this regard, the prism sheets 105 are configured to refract and integrate the light, to increase the brightness. Generally, two prism sheets 105 are arranged to be perpendicular to each other.

The protection sheet 106 is configured on the prism sheets 105. When the two prism sheets 105 arranged to be perpendicular to each other are used, the protection sheet 106 can protect the prism sheets 105 from scratch, and avoid a phenomenon of Moire Effect. The backlight module of the conventional LCD includes the foregoing components.

Generally, when the prism sheets 105 are normally installed, a plurality of prisms are arranged on a transparent material film in a regular direction. The prism sheets 105 are configured to refract the light passing through the light guide plate 102 and diffused by the diffusion sheet 104. Generally, if the transmission and retraction widths of the light are relatively small, the light in transmission and retraction areas is relatively bright. On the contrary, if the transmission and retraction widths of the light are relatively large, the light in transmission and retraction areas is relatively dim.

Recently, LCDs are developed to have large-size panels. To maintain the density of light emitted by the backlight module above a predetermined level and highlight a sense of unity of a display image, the LCDs are designed to be frame-less, but a problem of side light leakage at edges needs to be resolved after frames are canceled, and otherwise a phenomenon of peripheral light leakage occurs. In addition, when a frame-less product displays a panel array side upward, light reflected by surrounding metal causes a poor visual sense, affecting quality of the panel. Therefore, how to homogenize seen light and resolve the problem of side light leakage at edges is an important reference factor of the large-size panels.

A display apparatus of this application may include a backlight module and a display panel. The display panel may include a TFT substrate, a CF substrate, and an LC layer formed between the two substrates.

In an embodiment, the display panel of this application may be a curved-surface display panel, and the display apparatus of this application may also be a curved-surface display apparatus.

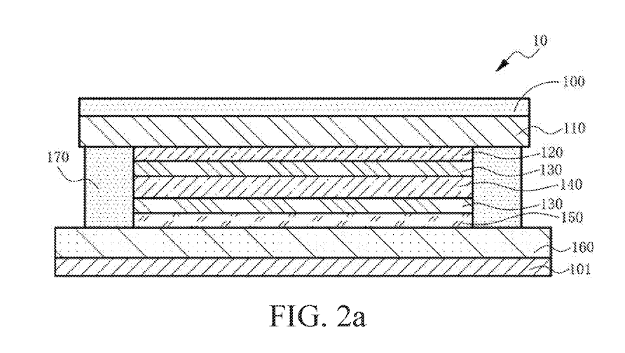

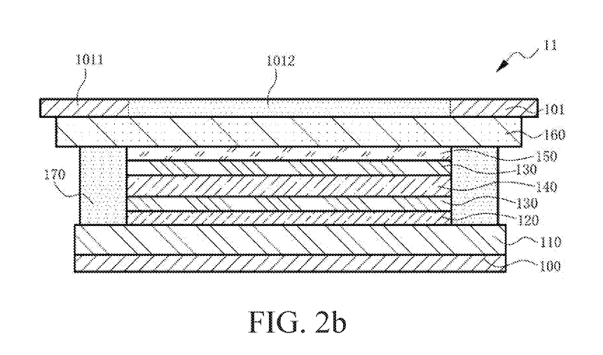

FIG. 2a is a schematic diagram of an exemplary panel array layer 10, and FIG. 2b is a schematic diagram of a display panel array layer 11 according to an embodiment of this application. Referring to FIG. 2a and FIG. 2b, in an embodiment of this application, a display panel 11 includes: a transparent substrate 110, having an outer surface; an active switch array substrate 160, disposed opposite to the transparent substrate 110, and having an outer surface, where the active switch array substrate 160 includes an active switch array 150 and a peripheral metal wiring, the active switch array 150 is disposed inside the active switch array substrate 160, and the peripheral metal wiring is disposed at a periphery of the active switch array 150; an LC layer 140, disposed between the transparent substrate 110 and the active switch array substrate 160; a seal 170, disposed at a periphery between the transparent substrate 110 and the active switch array substrate 160, and surrounding the LC layer 140; a first polarizer 101, having a translucent portion 1012 and a light shielding part 1011, disposed on the outer surface of the active switch array substrate 160, and covering the active switch array substrate 160; and a second polarizer 100, disposed on the outer surface of the transparent substrate 110.

In an embodiment of this application, the light shielding part 1011 of the polarizer 101 is located at the periphery of the polarizer 101, and surrounds the translucent portion 1012.

In an embodiment of this application, the light shielding part 1011 shields the peripheral metal wiring of the active switch array substrate 160.

In an embodiment of this application, the light shielding part 1011 is a dark light-absorbing material or a material with a low reflective rate.

In an embodiment of this application, the light shielding part 1011 is a carbonized material.

In an embodiment of this application, the light shielding part 1011 is formed by carbonizing the periphery of the polarizer 101 by using high-intensity light energy such as a laser or ultraviolet light. The light shielding part 1011 may be carbonized and formed by using the high-intensity light energy in a process of manufacturing the polarizer 101; or may be carbonized and formed by using the high-intensity light energy after the polarizer 101 is attached to the display panel 11.

In an embodiment of this application, one layer of photosensitive material is painted on the periphery of the polarizer 101. The high-intensity light energy is used to illuminate the periphery of the polarizer 101, and the periphery of the polarizer 101 is enabled to form the light shielding part 1011 by means of light reaction.

In an embodiment of this application, the light shielding part 1011 absorbs and blocks surrounding reflection light, and shields corresponding electronic circuits, so that a protection cover presents a black frame. During frame-less design, the light shielding part 1011 creates a design sense of having a frame, thereby achieving an aesthetic appearance.

In an embodiment of this application, a CF pattern 120 is located between the transparent substrate 110 and a photo spacer layer 130.

In an embodiment of this application, the active switch array 150 is located between the active switch array substrate 160 and the photo spacer layer 130.

In an embodiment of this application, the transparent substrate 110 and the active switch array substrate 160 are formed by using a process including photoresist painting, exposure, development, and mask.

In an embodiment of this application, the transparent substrate 110 is a CF substrate, and the active switch array substrate 160 is a TFT substrate.

In an embodiment of this application, the display panel 11 includes an LC layer 140, disposed between the transparent substrate 110 and the active switch array substrate 160.

Referring to FIG. 2a and FIG. 2b, in an embodiment of this application, a display apparatus includes a backlight module and a display panel 11. The display panel 11 includes: a transparent substrate 110, having an outer surface; an active switch array substrate 160, disposed opposite to the transparent substrate 110, and having an outer surface, where the active switch array substrate 160 includes an active switch array 150 and a peripheral metal wiring, the active switch array 150 is disposed inside the active switch array substrate 160, and the peripheral metal wiring is disposed at a periphery of the active switch array 150; an LC layer 140, disposed between the transparent substrate 110 and the active switch array substrate 160; a first polarizer 101, having a translucent portion 1012 and a light shielding part 1011, disposed on the outer surface of the active switch array substrate 160, and covering the active switch array substrate 160; and a second polarizer 100, disposed on the outer surface of the transparent substrate 110.

In an embodiment of this application, the light shielding part 1011 of the polarizer 101 is located at the periphery of the polarizer 101, and surrounds the translucent portion 1012.

In an embodiment of this application, the light shielding part 1011 shields the peripheral metal wiring of the active switch array substrate 160.

In an embodiment of this application, the light shielding part 1011 is a dark light-absorbing material or a material with a low reflective rate.

In an embodiment of this application, the light shielding part 1011 is a carbonized material.

In an embodiment of this application, the light shielding part 1011 is formed by carbonizing the periphery of the polarizer 101 by using high-intensity light energy such as a laser or ultraviolet light. The light shielding part 1011 may be carbonized and formed by using the high-intensity light energy in a process of manufacturing the polarizer 101; or may be carbonized and formed by using the high-intensity light energy after the polarizer 101 is attached to the display panel 11.

In an embodiment of this application, one layer of photosensitive material is painted on the periphery of the polarizer 101. The high-intensity light energy is used to illuminate the periphery of the polarizer 101, and the periphery of the polarizer 101 is enabled to form the light shielding part 1011 by means of light reaction.

In an embodiment of this application, the light shielding part 1011 absorbs and blocks surrounding reflection light, and shields corresponding electronic circuits, so that a protection cover presents a black frame. During frame-less design, the light shielding part 1011 creates a design sense of having a frame, thereby achieving an aesthetic appearance.

In an embodiment of this application, the active switch array 150 is located between the active switch array substrate 160 and the photo spacer layer 130.

In an embodiment of this application, the transparent substrate 110 and the active switch array substrate 160 are formed by using a process including photoresist painting, exposure, development, and mask.

In an embodiment of this application, the transparent substrate 110 is a CF substrate, and the active switch array substrate 160 is a TFT substrate.

In an embodiment of this application, the display panel 11 includes an LC layer 140, disposed between the transparent substrate 110 and the active switch array substrate 160.

In an embodiment of this application, the CF and the TFT may be disposed on a same substrate.

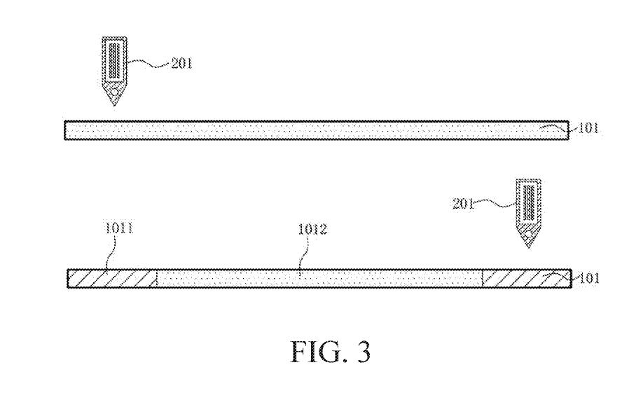

FIG. 3 is a manufacturing method of a polarizer 101 according to an embodiment of this application. Referring to FIG. 2a, FIG. 2b, and FIG. 3, this application further provides a display panel manufacturing method, including: providing a transparent substrate 110 and an active switch array substrate 160, where the active switch array substrate 160 has an outer surface and includes an active switch array 150 and a peripheral metal wiring, the active switch array 150 is disposed inside the active switch array substrate 160, and the peripheral metal wiring is disposed at a periphery of the active switch array 150; disposing an LC layer 140 between the transparent substrate 110 and the active switch array substrate 160; and disposing a first polarizer 101 on the outer surface of the active switch array substrate 160, where a periphery of the first polarizer 101 has a translucent portion 1012 and a light shielding part 1011, and a material property of the polarizer 101 is changed by using high-intensity light energy to illuminate the periphery of the polarizer 101 to form a carbonized light shielding part 1011 at the periphery of the polarizer 101.

In an embodiment of this application, the light shielding part 1011 shields the peripheral metal wiring or surrounding electronic elements of the active switch array substrate 160.

With continued reference to FIG. 3, in an embodiment of this application, the first polarizer 101 is disposed on the display panel 11, and high-intensity light energy 201 such as a laser or ultraviolet light is used to illuminate and carbonize the periphery of the first polarizer 101, to change the material property of the polarizer 101, so that the polarizer 101 is a dark light-absorbing material or a carbonized material with a low reflective rate, to replace a light shielding bar or a light shielding adhesive usually located in the display panel, thereby reducing the process.

In an embodiment of this application, the light shielding part 1011 may alternatively be carbonized and formed by using the high-intensity light energy in a process of manufacturing the polarizer 101, and the polarizer 101 is subsequently attached on the display panel 11.

In an embodiment of this application, one layer of photosensitive material is painted on the periphery of the polarizer 101. The high-intensity light energy is used to illuminate the periphery of the polarizer 101, and the periphery of the polarizer 101 is enabled to form the light shielding part 1011 by means of light reaction.

According to this application, light reflected by metal surrounding a TFT glass substrate can be absorbed, a problem of poor visual sense resulted from the light reflected by the metal is mitigated, and a scratch loss caused by flipping the substrate is reduced.

Terms such as “in some embodiments” and “in various embodiments” are repeatedly used. Usually, the terms do not refer to the same embodiment; but they may also refer to the same embodiment. Words such as “include”, “have”, and “include” are synonyms, unless other meanings are indicated in the context.

The foregoing descriptions are merely preferred embodiments of this application, but are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A display panel, comprising:
a transparent substrate;
an active switch array substrate, disposed opposite to the transparent substrate, and having an outer surface; and
a polarizer, disposed on the outer surface of the active switch array substrate, wherein
the polarizer has a light shielding part, disposed at a periphery of the polarizer.

2. The display panel according to claim 1, wherein the active switch array substrate comprises a peripheral metal wiring, disposed at a periphery of the active switch array substrate.

3. The display panel according to claim 1, wherein the light shielding part shields the peripheral metal wiring.

4. The display panel according to claim 1, wherein the light shielding part is a dark light-absorbing material or a material with a low reflective rate.

5. The display panel according to claim 1, wherein the light shielding part is a carbonized material.

6. The display panel according to claim 5, wherein the light shielding part is formed by carbonizing the periphery of the polarizer by using high-intensity light energy.

7. The display panel according to claim 6, wherein the high-intensity light energy is a laser or ultraviolet light.

8. A display panel manufacturing method, comprising:
providing a transparent substrate;
providing an active switch array substrate, disposed opposite to the transparent substrate and having an outer surface;
disposing a polarizer on the outer surface of the active switch array substrate; and
changing a material property of the polarizer by using high-intensity light energy to illuminate a periphery of the polarizer, to form a carbonized light shielding part at the periphery of the polarizer.

9. The manufacturing method according to claim 8, wherein the active switch array substrate comprises a peripheral metal wiring, disposed at a periphery of the active switch array substrate, and the light shielding part shields the peripheral metal wiring.

10. The manufacturing method according to claim 8, wherein the carbonized light shielding part is a dark light-absorbing material.

11. The manufacturing method according to claim 8, wherein the carbonized light shielding part is a material with a low reflective rate.

12. The manufacturing method according to claim 8, wherein the high-intensity light energy is a laser or ultraviolet light.

13. The manufacturing method according to claim 8, wherein the light shielding part is carbonized and formed by using the high-intensity light energy in a process of manufacturing the polarizer.

14. The manufacturing method according to claim 8, wherein the light shielding part is carbonized and formed by using the high-intensity light energy after the polarizer is attached.

15. A display panel, comprising:
a transparent substrate;
an active switch array substrate, disposed opposite to the transparent substrate, and having an outer surface;
a liquid crystal (LC) layer, disposed between the transparent substrate and the active switch array substrate;
a seal, disposed at a periphery between the transparent substrate and the active switch array substrate, and surrounding the LC layer; and
a polarizer, disposed on the outer surface of the active switch array substrate, wherein
the active switch array substrate comprises a peripheral metal wiring, disposed at a periphery of the active switch array substrate;
the polarizer has a light shielding part, disposed at a periphery of the polarizer, and the light shielding part shields the peripheral metal wiring;
the light shielding part is formed by carbonizing the periphery of the polarizer by using high-intensity light energy, and the high-intensity light energy is a laser or ultraviolet light; and
the light shielding part is a carbonized material, and the light shielding part is a dark light-absorbing material or a material with a low reflective rate.
